(19) United States
(12) Patent Application Publication
(10) Pub. No.: US 2025/0220754 A1
(43) Pub. Date: Jul. 3, 2025

(54) INFORMATION PROCESSING SYSTEM, INFORMATION PROCESSING APPARATUS, AND INFORMATION PROCESSING METHOD

(71) Applicant: TOYOTA JIDOSHA KABUSHIKI KAISHA, Toyota-shi (JP)

(72) Inventors: Satoshi OMI, Tokyo (JP); Chunghan LEE, Yokohama-shi (JP); Lei ZHONG, Tokyo (JP); Toru FURUSAWA, Yokohama-shi (JP); Hiroshi ABE, Kasukabe-shi (JP)

(73) Assignee: TOYOTA JIDOSHA KABUSHIKI KAISHA, Toyota-shi (JP)

(21) Appl. No.: 18/977,330

(22) Filed: Dec. 11, 2024

(30) Foreign Application Priority Data
Dec. 28, 2023 (JP) 2023-222734

(51) Int. Cl. H04W 76/18; H04W 80/10

(52) U.S. Cl. CPC H04W 76/18; H04W 80/10

(57) ABSTRACT

Information processing includes a first network function (NF) configured to: receive a first request from a terminal, the first request being a request to establish a session with a user plane in relation to a first service; and determine whether to establish a session with a user plane for the first request based on a first condition to permit or reject establishment of the session in relation to the first service.

### CROSS-REFERENCE TO RELATED APPLICATION

This application claims priority to Japanese Patent Application No. 2023-222734 filed on Dec. 28, 2023, incorporated herein by reference in its entirety.

### BACKGROUND

### 1. Technical Field

The disclosure relates to an information processing system, an information processing apparatus, and an information processing method.

### 2. Description of Related Art

A communication apparatus and a communication method are described (for example, Japanese Unexamined Patent Application Publication No. 2021-033558 (JP 2021-033558 A)). The communication apparatus and the communication method adjust a communication range with another vehicle based on a location and speed of a vehicle to adjust the amount of information to be processed according to the location and speed of the vehicle, and reduces the occurrence of inconvenience due to excessive communication beforehand.

### SUMMARY

The disclosure provides an information processing system, an information processing apparatus, and an information processing method capable of reducing the amount of electric power consumption for communication.

A first aspect of the disclosure provides an information processing system. The information processing system includes a first network function (NF) configured to: receive a first request from a terminal, the first request being a request to establish a session with a user plane in relation to a first service; and determine whether to establish the session with the user plane for the first request based on a first condition to permit or reject establishment of the session in relation to the first service.

A second aspect of the disclosure provides an information processing apparatus. The information processing apparatus includes a controller configured to: receive a first request from a terminal, the first request being a request to establish a session with a user plane in relation to a first service; and determine whether to establish the session with the user plane for the first request based on a first condition to permit or reject establishment of the session in relation to the first service.

A third aspect of the disclosure provides an information processing method. The information processing method includes: by a computer, receiving a first request from a terminal, the first request being a request to establish a session with a user plane in relation to a first service; and determining whether to establish the session with the user plane for the first request based on a first condition to permit or reject establishment of the session in relation to the first service.

According to the aspects of the disclosure, it is possible to reduce the amount of electric power consumption for communication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that shows an example of an architecture of a fifth generation mobile communication system;

FIG. 2 is a diagram that illustrates a session establishment determination process in the communication system;

FIG. 3 is a block diagram that shows an example of the hardware configuration of an information processing apparatus;

FIG. 4 is a block diagram that shows an example of the functional configuration of an SMF;

FIG. 5 is an example of a flowchart of a process of determining whether to establish a PDU session of the SMF;

FIG. 6 is an example of a sequence of a process of receiving designation of a session establishment reject condition from an AF;

FIG. 7 is a view that shows an example of a sequence of a session establishment determination process in a case where establishment of a PDU session is rejected; and

FIG. 8 is a view that shows an example of a sequence of a session establishment determination process in a case where an AMF determines whether to establish a PDU session.

### DETAILED DESCRIPTION OF EMBODIMENTS

For example, in a service that provides a terminal with information on a point of interest (POI) present around the terminal, the terminal and a server that provides the service periodically communicate with each other, so the terminal consumes electric power by receiving the benefit of the service. In such a service, useless information even when provided to a user can be provided. For example, when a vehicle is driving on an expressway, information on a facility or the like that the vehicle can reach only when the vehicle drives on an ordinary road and that is present in a range to an intended interchange is more likely to be useless even when the information is provided to a user because an occupant of the vehicle is less likely to make a stop at the facility.

In one aspect of the disclosure, establishment of a useless session is reduced by determining whether to establish a session for providing a service in relation to a terminal based on a condition designated by the service, with the result that, for example, electric power consumption for communication of the terminal is reduced. More specifically, one aspect of the disclosure is a system. The system includes a first network function (NF) and a second NF. The first NF is configured to receive a first request from a terminal, the first request being a request to establish a session with a user plane in relation to a first service, and determine whether to establish a session with a user plane for the first request based on a first condition to permit or reject establishment of the session in relation to the first service. The second NF is configured to receive designation of the first condition.

The system is, for example, a 5th generation (5G) or later mobile communication core network system. Each of the first NF and the second NF is, for example, an instance that acts as a predetermined function in the mobile communication core network. When the system is a 5G mobile communication core network, the first NF is, for example, a session management function (SMF) or an access and mobility management function (AMF). The second NF is, for example, a network exposure function (NEF). Each of the instances, that is, the first NF and the second NF, is, for example, implemented by executing virtual computing like a container on an information processing apparatus. When the system is a 5G mobile communication core network, a session with a user plane is a protocol data unit (PDU) session. However, the system, the first NF, the second NF, and the session with the user plane are not limited to the above-described ones.

The first condition may include a condition on a location of the terminal. Alternatively, the first condition may include a condition on a time period. The first condition may include a condition on a moving speed of the terminal. The first condition may include a condition on a moving direction of the terminal. When the first condition is satisfied, the first NF may determine to reject establishment of the session and transmit a reject response to the terminal.

In one aspect of the disclosure, when a request to establish a session with a user plane from the terminal is received, it is determined whether to permit or reject establishment of the session based on the first condition designated by the intended first service. When it is determined to reject establishment of the session, the session is not established, so it is possible to reduce consumption of electric power of the terminal and other apparatuses associated with establishment of the session and communication using the session.

The first condition is allowed to be designated from an application that provides the first service, so it is possible to flexibly set a condition to permit or reject establishment of the session according to characteristics of the first service.

Another aspect of the disclosure may be an information processing apparatus that operates as the first NF in the system. The information processing apparatus includes a controller configured to receive a first request from a terminal, the first request being a request to establish a session with a user plane in relation to a first service, and determine whether to establish a session with a user plane for the first request based on a first condition to permit or reject establishment of the session in relation to the first service. Another aspect of the disclosure is a method in which a computer executes a process that is executed by the information processing apparatus, a program for causing a computer to execute the method, or a non-transitory computer-readable recording medium on which the program is recorded.

Hereinafter, embodiments of the disclosure will be described with reference to the accompanying drawings. The configurations of the following embodiments are illustrative, and the disclosure is not limited to the configurations of the embodiments.

### First Embodiment

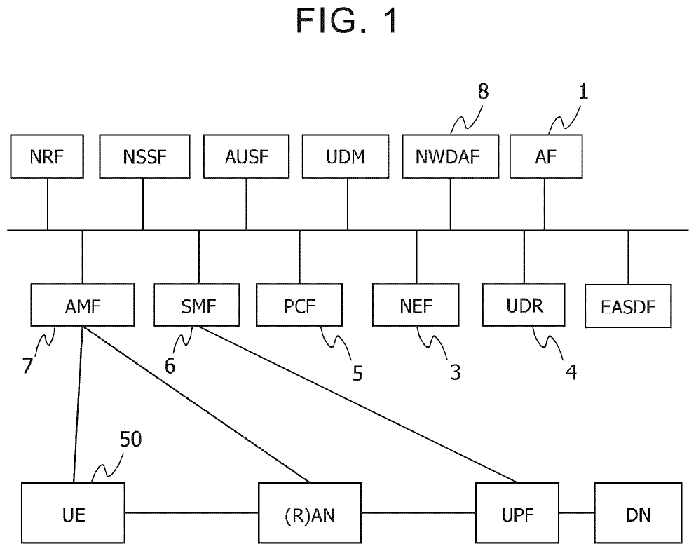

FIG. 1 is a diagram that shows an example of an architecture of a fifth generation mobile communication system. Hereinafter, a fifth generation mobile communication network is referred to as a 5G network. The 5G network includes a 5G core network (5GC) and an access network ((R) AN). A user equipment (UE) 50, a data network (DN), and an AF 1 are connected to the 5G network. The UE 50 is a terminal of a user (subscriber). A radio access network (RAN) is an access network to the 5GC. The RAN includes a base station (gNB).

FIG. 1 shows some of component elements included in the 5GC. In FIG. 1, reference signs are assigned to the component elements according to a first embodiment. In 5G, software that implements network functions and hardware on which the software is executed are separated by using a hardware abstraction technology. With this technology, pieces of software with various network functions are allowed to operate on common hardware resources without depending on the configuration of each hardware product. FIG. 1 shows network functions (NFs) included in the 5GC. Each of the NFs included in the 5GC is implemented by one or two or more computers (information processing apparatuses) running programs. However, a single computer may implement any two or more of the NFs.

A user plane function (UPF) performs routing, transfer, packet inspection, and QoS processing of a user packet. The user packet is a user plane packet that the UE 50 transmits and receives.

An access and mobility management function (AMF) 7 involves the RAN and performs registration management, connection management, and mobility management of the UE 50 in the 5GC. The AMF 7 relays a message between an SMF 6 and the UE 50.

The session management function (SMF) 6 performs management of a protocol data unit (PDU) session, allocation and management of an IP address to the UE 50, and selection and control of the UPF. Management of the PDU session includes establishment, modification, and releasing of the PDU session. For example, when a policy is changed, modification of a PDU session occurs, and modification of QoS or policy is applied to the UPF through the SMF 6. The PDU session is a virtual communication path for exchanging data between the UE 50 and the DN. The DN is a data network (such as a cloud and the Internet) outside the 5GC.

A policy control function (PCF) 5 provides a policy rule to each NF to implement a policy rule. The policy rule includes, for example, rules on QoS, filtering, routing, billing, and the like. When the policy rule is registered, modified, or deleted, this information is initially provided to the PCF 5, and the PCF 5 controls setting, modification, deletion, or the like of the policy for an appropriate UPF through the SMF 6.

A UDR 4 saves data used in unified data management (UDM), the PCF 5, and the NEF 3 and provides searching for these pieces of data.

The NEF 3 provides a function to disclose ability and event information disclosed by the network functions in the 5G system safely to external applications such as an application function (AF) 1. The NEF 3 provides a function to receive information from permitted external applications into the network. The AF 1 is an application server (external server) that provides an auxiliary service other than 5GC specifications.

An NWDAF 8 provides in-network analysis information. Examples of the in-network analysis information provided by the NWDAF 8 include communication delay in each section, throughput, jitter, and traffic load level.

An edge application server discovery function (EASDF) intermediates communication between the UE 50 and a DNS server.

An NRF stores and manages information on NFs (for example, AMF, SMF, UPF, and the like) in the 5GC. The NRF is capable of returning a plurality of NF candidates to an inquiry source in response to an inquiry about an NF desired to be used. An NSSF has a function to select a network slice to be used by a subscriber from among network slices generated by network slicing. A network slice is a virtual network having specifications according to a use. An AUSF provides a function of UE authentication. A UDM holds subscriber contract information and authentication information for AKA authentication.

In the 5GC, a plurality of NFs of the same type can be prepared. For example, a single NF can be prepared for each data center (station building). A single NF can be shared between data centers. A single data center can configure a plurality of NFs of the same type. A correspondence relationship between NF and data center can be set as needed.

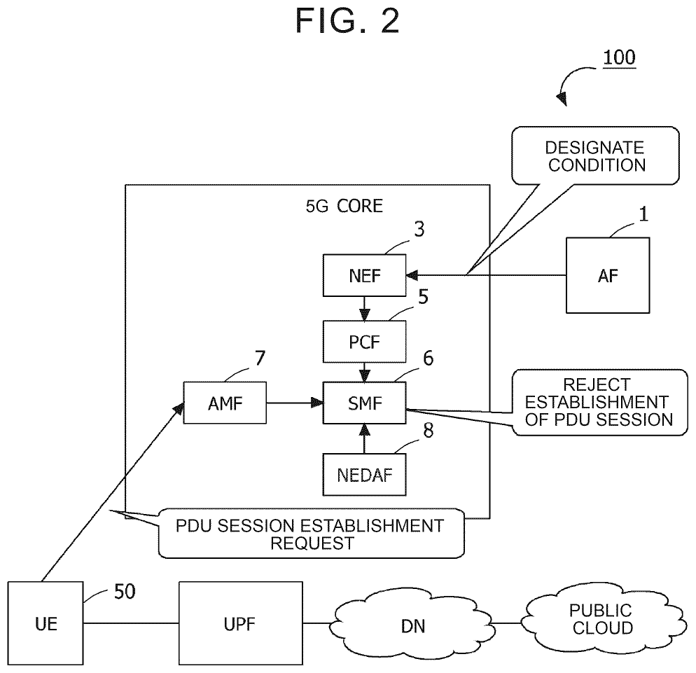

FIG. 2 is a diagram that illustrates a session establishment determination process in a communication system 100. The session establishment determination process is a process of determining whether to permit or reject establishment of a PDU session when a request to establish a PDU session is received from the UE 50.

The communication system 100 includes the 5GC, the UE 50, the UPF, the DN, and the AF 1. FIG. 2 shows the NEF 3, the PCF 5, the SMF 6, the AMF 7, and the NWDAF 8 related to the session establishment determination process and extracted from among the NFs included in the 5GC are shown in the communication system 100. However, the NFs associated with the session establishment determination process are not limited to these.
(1) The AF 1 is, for example, a server that provides a service to distribute predetermined information. The AF 1 sets a session establishment reject condition on the 5G core network through the NEF 3. The session establishment reject condition is a condition to reject establishment of a PDU session. A session establishment reject condition is a condition to reject establishment of a PDU session because information distribution to the UE 50 is not needed in a service provided by the AF 1 for the UE 50. In the first embodiment, a state where the UE 50 is mounted on a vehicle and the vehicle is driving on an expressway is assumed as one of states where information distribution to the UE 50 is not needed. Therefore, in a first embodiment, the session establishment reject condition is regarded as a condition for detecting that the UE 50 is driving on an expressway. In the first embodiment, the session establishment reject condition includes, for example, a geometrical range to reject establishment of a PDU session when the UE 50 is located, a time period to reject establishment of a PDU session, a moving speed of the UE 50, a moving direction of the UE 50, and the like. The session establishment reject condition is, for example, set in the SMF 6 through the NEF 3 and the PCF 5 together with service identification information for identifying a service that the AF 1 provides to the UE 50. The session establishment reject condition is an example of the “first condition”. The NEF 3 is an example of the “second NF”. The service that the AF 1 provides to the UE 50 is an example of the “first service”.
(2) A PDU session establishment request is transmitted from the UE 50. Identification information of a service that the AFI provides to the UE 50 is also transmitted together with the PDU session establishment request. The PDU session establishment request from the UE 50 is received by the AMF 7 and transferred to the SMF 6. The PDU session establishment request is an example of the “first request”.
(3) When the SMF 6 receives a PDU session establishment request from the UE 50, the SMF 6 determines whether the request satisfies the session establishment reject condition. The SMF 6, for example, sends an inquiry to the NWDAF 8 and acquires information on the UE 50 used to determine whether the session establishment reject condition is satisfied. For example, information on a moving speed, a moving direction, and the like, can be acquired form the NWDAF 8. For example, when the UE 50 is located in a geometrical range included in the session establishment reject condition, the SMF 6 determines to reject establishment of the PDU session in response a PDU session establishment request. In the first embodiment, the SMF 6 is an example of the “first NF”.

In the first embodiment, in a case where the condition to reject establishment of the PDU session is satisfied because the service that the AF 1 provides to the UE 50 is not needed for the UE 50, even when a PDU session establishment request is transmitted from the UE 50, the request is rejected, and a PDU session is not established between the UE 50 and the DN. Thus, since the PDU session itself of the service that the AF 1 provides to the UE 50 is not established, not only communication for the service to the UE 50 but also communication associated with establishment and management of the PDU session occurs, so it is possible to cut electric power consumption of the UE 50. Since the PDU session is not established, it is also possible to cut electric power consumption of apparatuses in the 5G core network associated with establishment and management of the PDU session.

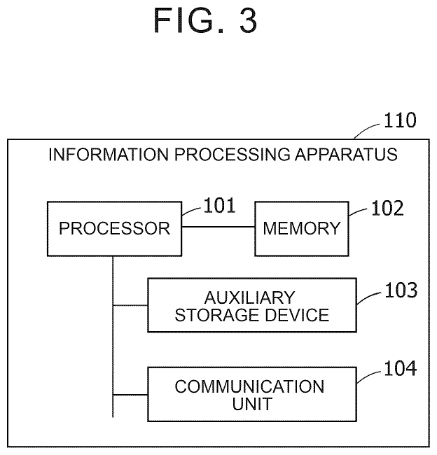

FIG. 3 is a block diagram that shows an example of the hardware configuration of an information processing apparatus capable of operating as each of the NFs and the AF 1 in the 5G core network. The information processing apparatus 110 can be configured by using an information processing apparatus (computer), such as a personal computer (PC), a workstation (WS), and a server machine. The information processing apparatus 110 may be an aggregate (cloud) of one or two or more computers. Each of the NFs and the AF 1 in the 5G core network may be an apparatus including an electrical circuit, such as a dedicated field-programmable gate array (FPGA) and an exclusive application specific integrated circuit (ASIC) that executes an intended process.

The information processing apparatus 110 includes a processor 101, a memory 102, an auxiliary storage device 103, and a communication unit 104 as the hardware configuration. The memory 102 and the auxiliary storage device 103 are computer-readable recording media. The processor 101, the auxiliary storage device 103, and the communication unit 104 are electrically connected by a bus.

The auxiliary storage device 103 stores programs used to operate as any one of the NFs and the AF 1 in the 5G core network and data that the processor 101 uses at the time of running the programs. The auxiliary storage device 103 is, for example, an erasable programmable ROM (EPROM), a hard disk drive, or a solid state drive (SSD). The programs held in the auxiliary storage device 103 are, for example, an operating system (OS), a control program for an intended NF or AF, and the like.

The memory 102 is a storage device that provides a storage area and a work area for loading programs stored in the auxiliary storage device 103 to the processor 101 and that is used as a buffer. The memory 102 includes, for example, a read only memory (ROM) and a semiconductor memory, such as a random access memory (RAM).

The processor 101 executes a process corresponding to any one of the NFs and the AFI in the 5G core network by loading an OS held in the auxiliary storage device 103 and a program related to the any one of the NFs and the AF 1 in the 5G core network to the memory 102 and running the OS and the program. The processor 101 is, for example, a CPU, a digital signal processor (DSP), or the like. The number of the processors 101 is not limited to one and may be multiple. The processor 101 is an example of the “controller”.

The communication unit 104 is, for example, a network interface card (NIC), an optical line interface, or the like. The communication unit 104 may be, for example, a wireless communication circuit that connects with a wireless network, such as a wireless LAN. The hardware configuration of the information processing apparatus 110 that implements the functions of the NFs and the AF 1 in the 5G core network is not limited to the one shown in FIG. 3.

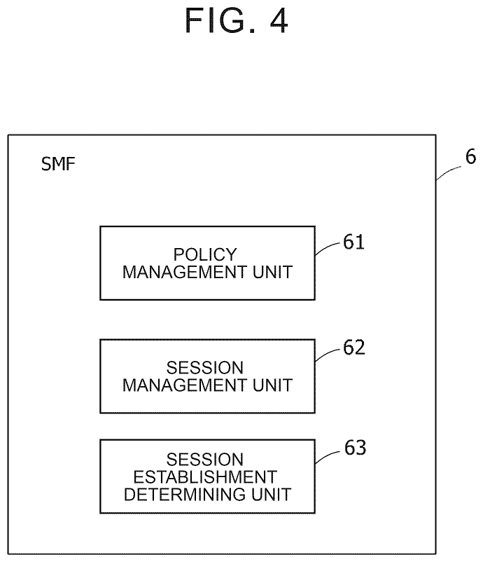

FIG. 4 is a block diagram that shows an example of the functional configuration of the SMF 6. The SMF 6 includes a policy management unit 61, a session management unit 62, and a session establishment determining unit 63 as functional components. However, in FIG. 4, of the functional components of the SMF 6, the functional components associated with the session establishment determination process are extracted and shown, and the functional components of the SMF 6 are not limited to the ones shown in FIG. 4.

The policy management unit 61 manages a management policy for a PDU session. For example, a management policy of a PDU session is received from the PCF 5. In the first embodiment, the policy management unit 61 receives a session establishment reject condition as one of the management policies for a PDU session from the PCF 5. The policy management unit 61 may be, for example, an API for Npcf_SMPolicyControl service.

The session management unit 62 manages a PDU session in accordance with a policy managed by the policy management unit 61. The session management unit 62, for example, selects a UPF or performs setting for a UPF at the time of establishing a PDU session. The session management unit 62 may be, for example, an API for Nsmf_PDUSession service.

When a request to establish a PDU session is received, the session establishment determining unit 63 determines whether to permit or reject establishment of the PDU session based on the session establishment reject condition. In the first embodiment, the session establishment determining unit 63 sends an inquiry to the NWDAF 8 and acquires information on the UE 50 that is a source of transmission of a request to establish a PDU session. The information on the UE 50 is used to determine whether to permit or reject establishment of the PDU session. The session establishment determining unit 63 outputs the result of determination as to whether to permit or reject establishment of the PDU session to the session management unit 62. When the session establishment determining unit 63 determines to permit establishment of the PDU session, the session management unit 62 continues a process for establishing a PDU session. When the session establishment determining unit 63 determines to reject establishment of the PDU session, the session management unit 62 transmits a response to reject establishment of a PDU session to the UE 50.

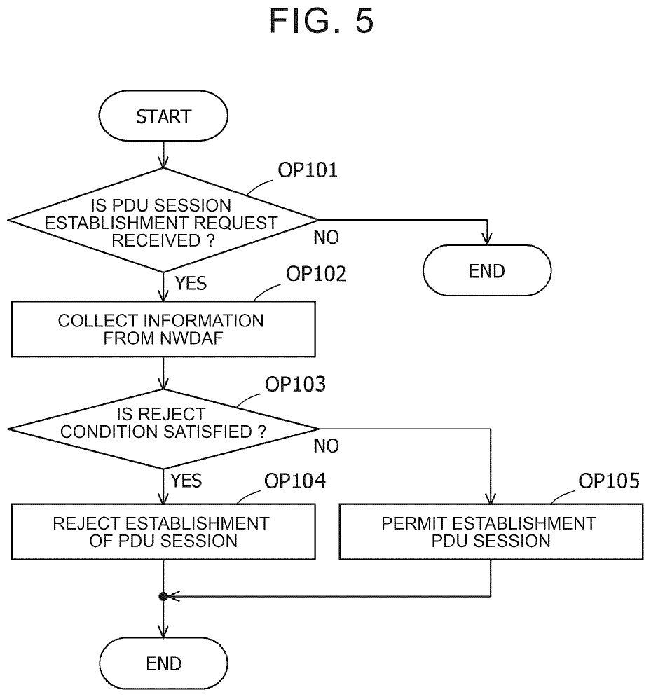

FIG. 5 is an example of a flowchart of a process of determining whether to permit or reject establishment of a PDU session of the SMF 6. The process shown in FIG. 5 is, for example, repeatedly executed at predetermined intervals during operation of the SMF 6. In OP101, the session establishment determining unit 63 determines whether a PDU session establishment request is received from the UE 50. When a PDU session establishment request is received from the UE 50 (YES in OP101), the process proceeds to OP102. When a PDU session establishment request is not received from the UE 50 (NO in OP101), the process shown in FIG. 5 ends.

In OP102, the session establishment determining unit 63 sends an inquiry to the NWDAF 8 and acquires information on the UE 50 that is a source of transmission of the PDU session establishment request. For example, the session establishment determining unit 63 acquires, from the NWDAF 8, information on a moving speed, a moving direction, and the like, of the UE 50.

In OP103, the session establishment determining unit 63 determines whether the PDU session establishment request is for a service that the AF 1 provides to the UE 50 and whether the session establishment reject condition is satisfied. For example, identification information of the service that the AF 1 provides to the UE 50 and information indicating the location of the UE 50 are also received together with the PDU session establishment request. The identification information of the service that the AF 1 provides to the UE 50 is, for example, one or combination of an IP address and a port number of the AF 1 or a server associated with the service, identification information of the DN that the AF 1 connects with, an application ID, identification information of an authentication server of the application, and the like. The identification information of the DN is, for example, a data network name (DNN). The identification information of the authentication server is, for example, an IP address or the like. The information that indicates the location of the UE 50 is, for example, cell ID, tracking area identity (TAI), or the like. The identification information of the service that the AF 1 provides to the UE 50 and the information that indicates the location of the UE 50 each are not limited thereto.

When the session establishment reject condition is satisfied (YES in OP103), the process proceeds to OP104. In OP104, the session establishment determining unit 63 determines to reject establishment of the PDU session in response to the PDU session establishment request and outputs a determination result to the session management unit 62. When the session management unit 62 receives the determination result to reject establishment of the PDU session, the session management unit 62 transmits, to the UE 50, a response to reject establishment of the PDU session. The response to reject establishment of the PDU session is transmitted to the UE 50 through the AMF 7. Together with a response to reject establishment of the PDU session, information indicating that the cause of rejection is a PDU session establishment rejection by the application is also transmitted.

When the session establishment reject condition is not satisfied (NO in OP103), the process proceeds to OP105. In OP105, the session establishment determining unit 63 determines to permit establishment of the PDU session in response to the PDU session establishment request and outputs a determination result to the session management unit 62. When the session management unit 62 receives the determination result to permit establishment of the PDU session, the session management unit 62 continues the process of establishing the PDU session. After that, the process shown in FIG. 5 ends.

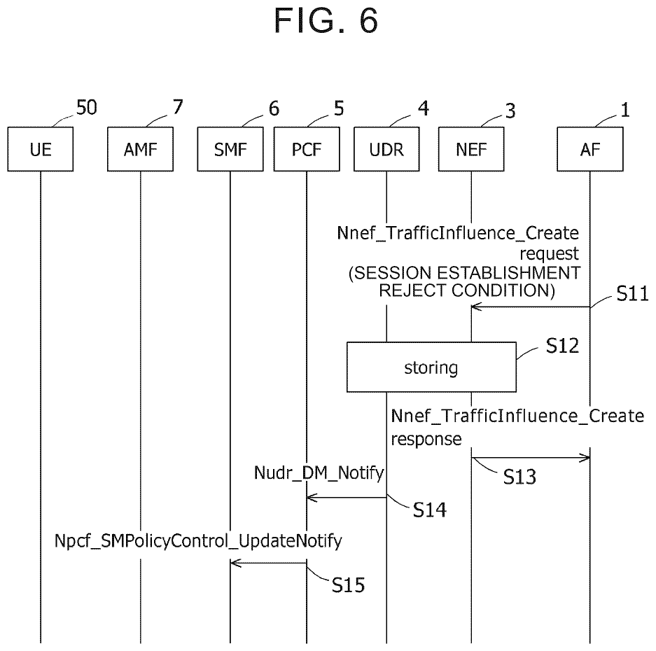

FIG. 6 is an example of a sequence of a process of receiving designation of the session establishment reject condition from the AF 1. In S11, for example, the AF 1 receives input of the session establishment reject condition from an administrator of the AF 1 and transmits, to the NEF 3, a request to set the session establishment reject condition. In the first embodiment, the session establishment reject condition is a condition for detecting that the UE 50 is driving on an expressway. For this reason, for example, a session establishment condition is that the UE 50 is located in a geometrical range in which an expressway is located, a moving speed of the UE 50 is higher than or equal to a threshold, and a moving direction of the UE 50 is along an expressway. The session establishment condition for detecting that the UE 50 is driving on an expressway is not limited thereto. The session establishment condition may be that at least any one of the above-described three conditions is satisfied.

For example, a request to set the session establishment reject condition is transmitted to the 5G core network by using an Nnef_TrafficInfluence_Create request message requesting for setting on a PDU session. Together with the Nnef_TrafficInfluence_Create request message, the session establishment reject condition and the identification information of the service that the AF 1 provides to the UE 50 are also transmitted. The identification information of the service that the AF 1 provides to the UE 50 is, for example, one or combination of an IP address and a port number of the AF 1 or a server associated with the service, identification information of the service, identification information of the DN that the AF 1 connects with, identification information of an authentication server of the service, and the like. When the session establishment reject condition includes a geometrical range in which establishment of the PDU session is rejected in a case where the UE 50 is located, the geometrical range may be designated from an administrator by, for example, longitude and latitude, address, or the like and transmitted to the NEF 3.

In S12, the NEF 3 receives the Nnef_TrafficInfluence_Create request message from the AF 1, and stores the session establishment reject condition in the UDR 4. establishment For example, the session condition may be stored as RouteSelection ValidationCriteria. At this time, the NEF 3 converts the geometrical range in which establishment of the PDU session is rejected in a case where the UE 50 is located, included in the session establishment reject condition, from longitude and latitude, address, or the like to information indicating a location used in the 5G core network, such as cell ID and TAI. In S13, the NEF 3 transmits an Nnef_TrafficInfluence_Create response message to the AF 1.

In S14, the UDR 4 transmits, to the PCF 5, an Nudr_DM_Notify message that notifies that the session establishment reject condition is set. Together with the Nudr_DM_Notify message, the session establishment reject condition and the identification information of the service that the AF 1 provides to the UE 50 are transmitted.

In S15, the PCF 5 transmits, to the SMF 6, an Npcf_SMPolicyControl_UpdateNotify message that provides a policy applied to the PDU session. Together with the Npcf_SMPolicyControl_UpdateNotify message, the session establishment reject condition and the identification information of the service that the AF 1 provides to the UE 50 are transmitted. When the SMF 6 receives the Npcf_SMPolicyControl_UpdateNotify message from the PCF 5, the SMF 6 applies the received session establishment reject condition. After that, when the SMF 6 receives, from the UE 50, a request to establish the PDU session, the SMF 6 executes the process of determining establishment of the PDU session based on the session establishment reject condition.

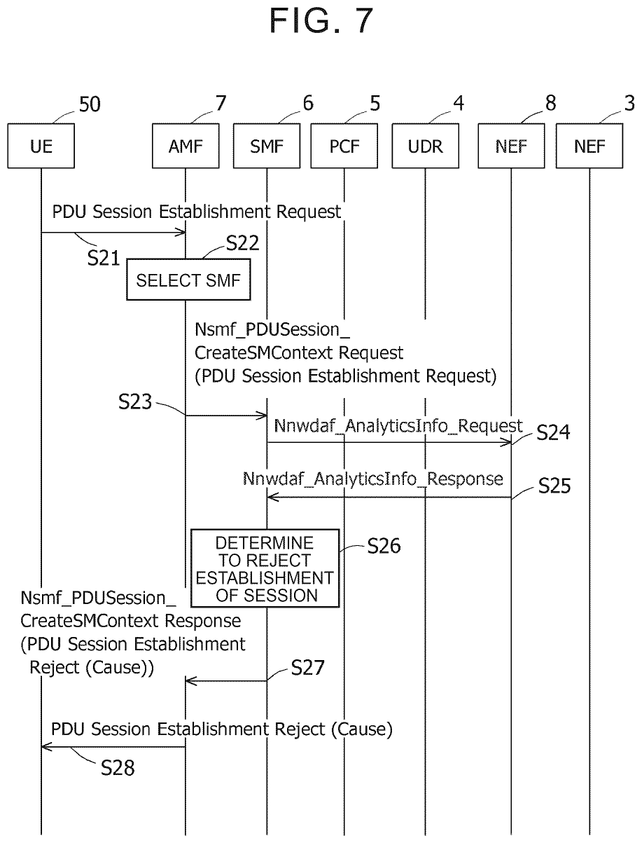

FIG. 7 is a view that shows an example of a sequence of a session establishment determination process in a case where establishment of a PDU session is rejected. In S21, the UE 50 transmits a PDU Session Establishment Request message as a request to establish the PDU session in relation to the service that the AF 1 provides to the UE 50. The PDU Session Establishment Request message is one of NAS messages. Together with the PDU Session Establishment Request message, identification information of the service that the AF 1 provides to the UE 50 is also transmitted. The identification information of the service that the AF 1 provides to the UE 50 is, for example, information of the same type as the identification information of the service that the AF 1 provides to the UE 50 and transmitted together with the session establishment reject condition in S11. The PDU Session Establishment Request message is, for example, added with information or the like indicating the location of the UE 50, converted to an N2 message, and reaches the AMF 7, in an access network ((R) AN). Information that indicates the location of the UE 50 and that is added in the (R) AN is, for example, cell ID, TAI, or the like.

In S22, the AMF 7 receives the PDU Session Establishment Request message from the UE 50 and selects an SMF. Selection of an SMF is, for example, performed in compliant with the contents described in 4.3.2.2.3 SMF selection in 3GPP TS 23.502. In S23, the AMF 7 transmits an Nsmf_PDUSession_CreateSMContext request message making a request of the selected SMF 6 to create an SM context including setting information of the PDU session. Together with the Nsmf_PDUSession_CreateSMContext request message, the PDU Session Establishment Request message, information that indicates the location of the UE 50, and the like are transmitted.

In S24, the SMF 6 receives the PDU Session Establishment Request message (YES in OP101) together with the Nsmf_PDUSession_CreateSMContext request message, and transmits, to the NWDAF 8, an Nnwdaf_AnalyticsInfo request message requesting for information on the UE 50 (OP102). The Nnwdaf_AnalyticsInfo request message includes “Movement Behaviour” as Analytics ID. In S25, the NWDAF 8 receives the Nnwdaf_AnalyticsInfo request message from the SMF 6 and transmits an Nnwdaf_AnalyticsInfo response message to the SMF 6. Together with the Nnwdaf_AnalyticsInfo response message, for example, the moving speed, moving direction, and the like of the UE 50 are transmitted as information on the UE 50.

In S25, the SMF 6 determines whether to permit or reject establishment of the PDU session based on the session establishment reject condition for the UE 50 (OP103). In the example shown in FIG. 7, the UE 50 is assumed to be mounted on a vehicle driving on an expressway. More specifically, the UE 50 makes a request to establish the PDU session for the service that the AF 1 provides to the UE 50, the UE 50 is located in a geometrical range in which the expressway is located, the moving speed is higher than or equal to a threshold, and the moving direction is along the expressway. In other words, the UE 50 is assumed to be in a situation in which the session establishment reject condition is satisfied. Therefore, in S26, the SMF 6 determines to reject establishment of the PDU session for the UE 50 (OP104).

In S27, the SMF 6 transmits an Nsmf_PDUSession_CreateSMContext response message to the AMF 7 (UE 50). Together with the Nsmf_PDUSession_CreateSMContext response message, a PDU Session Establishment Reject message that is a reject response to the PDU Session Establishment Request message to the UE 50 is also transmitted. The PDU Session Establishment Reject message includes information that indicates that rejection is performed by the application as a cause that establishment of the PDU session is rejected. Information that indicates a cause that establishment of the PDU session is rejected is, for example, code, flag, keyword, or the like.

In S28, the Nsmf_PDUSession_CreateSMContext response message transmitted from the SMF 6 in S27 reaches the AMF 7, and the AMF 7 converts the response message to a NAS Signaling message, and transmits the PDU Session Establishment Reject message to the UE 50. Thus, a PDU session is not established between the UE 50 and the DN for the service that the AF 1 provides. The sequences of the processes respectively shown in FIG. 6 and FIG. 7 are examples, and the type of a message, the order of processes, and the like may be modified as needed according to an embodiment and a situation. Operation and Advantageous Effects of First Embodiment

According to the first embodiment, when the session establishment reject condition designated by the administrator of the AF 1 is satisfied for a request to establish the PDU session from the UE 50, establishment of the PDU session is rejected. Thus, it is possible to cut electric power consumption associated with establishment of a PDU session of the UE 50 and an associated apparatus in the 5G core network through the PDU session.

### Modification

In the first embodiment, the SMF 6 determines whether to permit or reject establishment of a PDU session. Instead, the AMF 7 may determine whether to permit or reject establishment of a PDU session. In a modification, the AMF 7 executes the process flow shown in FIG. 5.

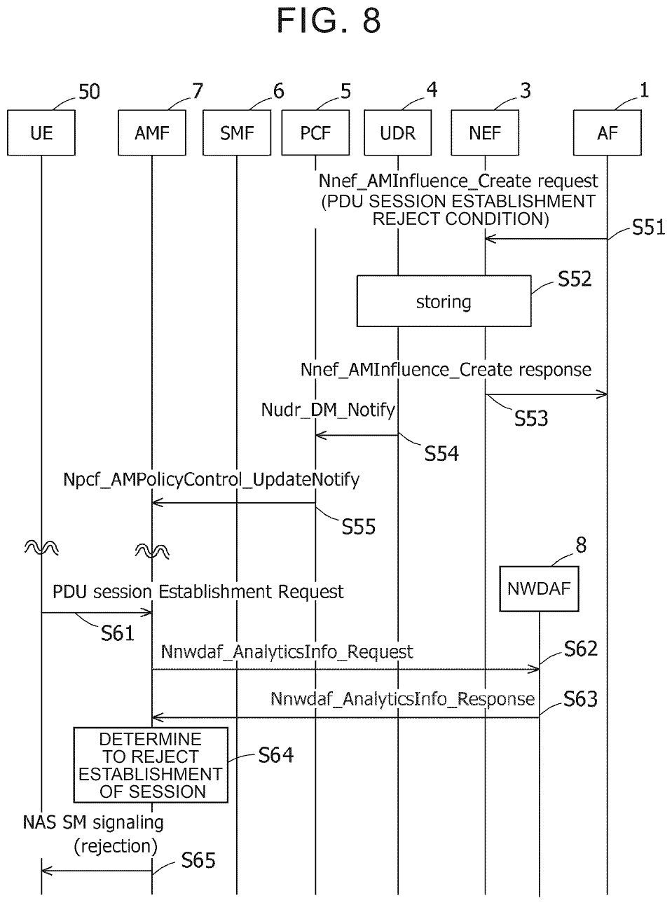

FIG. 8 is a view that shows an example of a sequence of a session establishment determination process in a case where the AMF 7 determines whether to establish a PDU session. The processes from S51 to S55 are processes of setting a session establishment reject condition designated by the AF 1 in the AMF 7.

In S51, for example, the AF 1 receives input of the session establishment reject condition from an administrator of the AF 1 and transmits, to the NEF 3, a request to set the session establishment reject condition. In FIG. 8, a request to set a session establishment reject condition is transmitted to the 5G core network by using the Nnef_AMInfluence_Create request message. Together with the Nnef_AMInfluence_Create request message, the session establishment reject condition and the identification information of the service that the AF 1 provides is also transmitted.

In S52, the NEF 3 receives the Nnef_AMInfluence_Create request message from the AF 1 and stores the session establishment reject condition in the UDR 4. In S53, the NEF 3 transmits the Nnef_AMInfluence_Create response message to the AF 1.

In S54, the UDR 4 transmits, to the PCF 5, an Nudr_DM_Notify message that notifies that the session establishment reject condition is set. Together with the Nudr_DM_Notify message, the session establishment reject condition and the identification information of the service that the AF 1 provides are transmitted.

In S55, the PCF 5 transmits, to the AMF 7, an Npcf_AMPolicyControl_UpdateNotify message that provides a policy of access and mobility management. Together with the Npcf_AMPolicyControl_UpdateNotify message, the session establishment reject condition and the identification information of the service that the AF 1 provides are transmitted. When the AMF 7 receives the Npcf_AMPolicyControl_UpdateNotify message from the PCF 5, the AMF 7 applies the received session establishment reject condition. After that, when the AMF 7 receives, from the UE 50, a request to establish the PDU session, the AMF 7 executes the process of determining establishment of the PDU session based on the session establishment reject condition.

In S61, the UE 50 transmits a PDU Session Establishment Request message as a request to establish the PDU session in response to the service that the AF 1 provides. Together with the PDU Session Establishment Request message, identification information of the service that the AF 1 provides is also transmitted. The PDU Session Establishment Request message is, for example, added with information or the like indicating the location of the UE 50, converted to an N2 message, and reaches the AMF 7, in an access network ((R)AN). Information that indicates the location of the UE 50 and that is added in the (R)AN is, for example, cell ID, TAI, or the like.

In S62, the AMF 7 receives the PDU Session Establishment Request message from the UE 50 and transmits, to the NWDAF 8, an Nnwdaf_AnalyticsInfo request message making a request for information on the UE 50. The Nnwdaf_AnalyticsInfo request message includes “Movement Behaviour” as Analytics ID. In S63, the NWDAF 8 receives the Nnwdaf_AnalyticsInfo request message from the AMF 7 and transmits an Nnwdaf_AnalyticsInfo response message to the AMF 7. Together with the Nnwdaf_AnalyticsInfo response message, for example, the moving speed, moving direction, and the like of the UE 50 are transmitted as information on the UE 50.

In S64, the AMF 7 determines whether to permit or reject establishment of the PDU session based on the session establishment reject condition for the UE 50. In the example shown in FIG. 8, the UE 50 is assumed to be mounted on a vehicle driving on an expressway in a situation in which the session establishment reject condition is satisfied. Therefore, in S64, the AMF 7 determines to reject establishment of the PDU session for the UE 50.

In S65, the AMF 7 transmits a NAS message to the UE 50. Together with a NAS Signaling message, information that indicates a reject response to the PDU Session Establishment Request message to the UE 50 and information that indicates that rejection is performed by the application as a cause that establishment of the PDU session is rejected are also transmitted. The sequence of the processes shown in FIG. 8 is an example, and the type of a message, the order of processes, and the like may be modified as needed according to an embodiment and a situation.

In the case of the example shown in FIG. 8, it is determined to reject establishment of the PDU session in the AMF 7 that receives the PDU Session Establishment Request message from the UE 50 the earliest in the 5G core network. Thus, it is possible to reduce a processing load on apparatuses such as the SMF 6 associated with establishment of the PDU session in the 5G core network.

### Other Embodiments

The above-described embodiment is only illustrative, and the disclosure can be implemented with modifications as needed without departing from the purport of the disclosure.

In the first embodiment, a session establishment reject condition that is a condition to reject establishment of a PDU session is used for a request to establish a PDU session. However, the configuration is not limited thereto. A session establishment permission condition that is a condition to permit a PDU session may be used. In this case, when the PDU session establishment permission condition is not satisfied, a reject response is transmitted to the UE 50.

The SMF 6 in the first embodiment and the AMF 7 in the modification determine whether to permit or reject establishment of a PDU session; however, the configuration is not limited thereto. A determination as to whether to permit or reject establishment of a PDU session may be performed in a manner such that an NF, different from the SMF 6 or the AMF 7, holds a session establishment reject condition and information on a request to establish a PDU session from the UE 50 is transferred from the SMF 6 or the AMF 7.

In the first embodiment, a process of determining whether to permit or reject establishment of a PDU session has been described on the assumption of the 5G core network; however, the configuration is not limited thereto. A session is not limited to a PDU session. The process of determining whether to permit or reject establishment of a PDU session is also applicable to a communication core network other than a 5G core network and also to a session with a user plane, other than a PDU session, is established.

In the first embodiment and the modification, a determination as to whether to permit or reject establishment of a PDU session is performed at the time of establishing a PDU session; however, the configuration is not limited thereto. The determination as to whether to permit or reject establishment of a PDU session, described in the first embodiment, may be applied to, for example, in a handover in a case where an access network to be connected changes as a result of movement of the UE 50, it is determined whether to maintain a PDU session associated with a service that the AF 1 provides to the UE 50 at a handover destination by using a session establishment reject condition.

For example, when the SMF 6 executes a process of determining whether to permit or reject establishment of a PDU session, the process is as follows. Initially, when the AMF 7 receives a handover request from the UE 50, the AMF 7 transmits, to the SMF 6, an Nsmf_PDUSession_UpdateSMContext request message making a request to switch the PDU session being established. Together with the Nsmf_PDUSession_UpdateSMContext request message, information that indicates a handover destination of the UE 50 is also transmitted. The information that indicates a handover destination of the UE 50 is, for example, cell ID or the like. When the SMF 6 receives the Nsmf_PDUSession_UpdateSMContext request message from the AMF 7, the SMF 6 executes a process of determining whether to permit or reject establishment of a PDU session of FIG. 5, for example, as in the case of the first embodiment. When the SMF 6 determines to reject establishment of a PDU session, the SMF 6 may instruct the AMF 7 to release the PDU session as a response to reject the PDU session. When the SMF 6 determines to reject establishment of a PDU session, the SMF 6 continuously executes the process of handover. Thus, when the session establishment reject condition is satisfied at a handover destination, the UE 50 is released from the PDU session of an intended application, so no unnecessary PDU session is present for the UE 50, with the result that electric power consumption of the UE 50 can be saved.

The processes and devices described in this disclosure may be freely implemented in combination unless there is a technical contradiction.

A process described as the one that is performed by a device may be shared and performed by multiple devices. Alternatively, processes described as the ones that are respectively performed by different devices may be performed by a single device. In a computer system, what hardware configuration (server configuration) implements functions may be flexibly changed.

The disclosure may also be implemented as follows. A computer is supplied with a computer program having the functions described in the above-described embodiments, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (CD-ROM, DVD disc, a Blue-ray disc, or the like), a read only memory (ROM). a random access memory (RAM). an EPROM, an EEPROM, a magnetic card, a flash memory, an optical card, and a medium of any type suitable for storing electronic instructions.

What is claimed is:

1. An information processing system comprising a first network function (NF) configured to:
receive a first request from a terminal, the first request being a request to establish a session with a user plane in relation to a first service; and
determine whether to establish the session with the user plane for the first request based on a first condition to permit or reject establishment of the session in relation to the first service.

2. The information processing system according to claim 1, wherein the first condition includes a condition on a location of the terminal.

3. The information processing system according to claim 1, wherein the first condition includes a condition on a time period.

4. The information processing system according to claim 1, wherein the first condition includes a condition on a moving speed of the terminal.

5. The information processing system according to claim 1, wherein the first condition includes a condition on a moving direction of the terminal.

6. The information processing system according to claim 1, wherein the first NF is configured to transmit a reject response to the terminal when the first NF determines to reject establishment of the session based on the first condition.

7. The information processing system according to claim 6, wherein the first NF is configured to transmit that a cause of rejection is designated by the first service together with the reject response.

8. The information processing system according to claim 1, wherein the first NF is a session management function (SMF).

9. The information processing system according to claim 1, further comprising a second NF configured to receive designation of the first condition from an application configured to provide the first service.

10. An information processing apparatus comprising a controller configured to:
receive a first request from a terminal, the first request being a request to establish a session with a user plane in relation to a first service; and
determine whether to establish the session with the user plane for the first request based on a first condition to permit or reject establishment of the session in relation to the first service.

11. The information processing apparatus according to claim 10, wherein the first condition includes a condition on a moving speed of the terminal.

12. The information processing apparatus according to claim 10, wherein the first condition includes a condition on a moving direction of the terminal.

13. The information processing apparatus according to claim 10, wherein the controller is configured to:
determine to reject establishment of the session when the first condition is satisfied; and
transmit a reject response to the terminal.

14. The information processing apparatus according to claim 13, wherein the controller is configured to transmit that a cause of rejection is designated by the first service together with the reject response.

15. The information processing apparatus according to claim 10, wherein the information processing apparatus is an apparatus that operates as a session management function (SMF).

16. An information processing method comprising: by a computer,
receiving a first request from a terminal, the first request being a request to establish a session with a user plane in relation to a first service; and
determining whether to establish the session with the user plane for the first request based on a first condition to permit or reject establishment of the session in relation to the first service.

17. The information processing method according to claim 16, wherein the first condition includes a condition on a moving speed of the terminal.

18. The information processing method according to claim 16, wherein the first condition includes a condition on a moving direction of the terminal.

19. The information processing method according to claim 16, further comprising: by the computer,
determining to reject establishment of the session when the first condition is satisfied; and
transmitting a reject response to the terminal.

20. The information processing method according to claim 16, wherein the computer is an apparatus configured to operate as a session management function (SMF).
